(19) United States
(12) Patent Application Publication
(10) Pub. No.: US 2009/0171864 A1
(43) Pub. Date: Jul. 2, 2009

(54) Methods and Systems for Displaying Mattresses by Color

(75) Inventors: Robert S. Stagner, Houston, TX (US); Kenneth Murphy, Houston, TX (US)

Correspondence Address: HAYNES AND BOONE, LLP;IP Section, 2323 Victory Avenue, Suite 700, Dallas, TX, 75219, US

(73) Assignee: Mattress Firm, Inc., Houston, TX (US)

(21) Appl. No.: 12/361,336

(22) Filed: Jan. 28, 2009

Related U.S. Application Data
(63) Continuation of application No. 11/964,588, filed on Dec. 26, 2007.

(51) Int. Cl. G09F 23/00; A47C 19/02; G06Q 90/00; A47G 9/10; A47C 31/00

(52) U.S. Cl. 705/500; 40/585; 5/663; 5/636

(57) ABSTRACT

A method for displaying a plurality of mattresses according to a color scheme is provided. The method includes categorizing a plurality of mattresses into at least three different types based on features of the mattresses other than size (e.g., based on comfort or style), designating a different color for each type of mattress, and displaying each of the mattresses with the designated color, or an article having the designated color, for the particular mattress type. For example, the article may include a pillow and/or foot protector having the designated color displayed prominently for a customer's reference. The method may further include grouping at least a portion of the mattresses together within the showroom based on the type of mattress, and displaying one of each type of mattress in a common region (e.g., a comparison center) for side-by-side comparisons of the different types of mattresses by customers.

### BACKGROUND

1. Field

The present invention relates generally to merchandising mattresses, and in one particular example, to a method for associating colors (or other non-text based visual indicators) with different types or styles of mattresses according to a color scheme for aiding customers in selecting and purchasing mattresses.

2. Related Art

Selecting and purchasing a mattress can be a difficult and time-consuming process, at least in part, because it is generally difficult for users to determine a type of mattress they desire (e.g., plush, firm, contoured, or the like) and to navigate a retail mattress store and differentiate types of mattress from different manufactures. For example, retail mattress stores typically group mattresses according to the manufacturers, which can make comparing different types of mattresses difficult (as not all manufactures make all types of mattresses, for example). Further, locating and selecting a particular type of mattress from different manufactures can be difficult because they are typically located in different locations of a showroom and have little to identify them beyond a tag or sales brochure. Some retail stores display or group mattresses according to broad categories, but provide no indication with the mattresses (beyond an attached tag or brochure) as to the type of mattress or the categories of mattresses.

Accordingly, customers often require the assistance of a salesperson to determine a type of mattress that suits them and further to guide the customer through the showroom to view mattresses of the particular type chosen. For example, a user may desire a plush mattress; however, finding available plush mattresses displayed within a showroom by the various manufacturers can be difficult because the plush mattresses are typically spread throughout the store according to the manufacturers. As such, a customer may spend considerable time examining and reading tags of various mattresses to locate the desired type of mattress. Further, different manufacturers may classify mattresses by different names or systems, which may result in further confusion and dissatisfaction by the customer.

### BRIEF SUMMARY

In one aspect of the present invention, methods for displaying a plurality of mattresses according to a color scheme are provided. In one example, the method includes categorizing a plurality of mattresses into at least three different types of mattresses based on features of the mattresses other than size (e.g., based on comfort or style), designating a different color for each type of mattress, and displaying each of the plurality of mattresses with an article, the article having the designated color for the particular mattress type. For example, the article may include a pillow and/or foot protector having the designated color displayed prominently for a customer. The method may further include grouping at least a portion of the plurality of mattresses together within the showroom based on the type of mattress.

In one example, the method further includes displaying a subset of the plurality of mattresses in a first region of the showroom, where the subset comprises one of each of the at least three different types of mattresses. Such a region (referred to herein as a “comparison center”) allows a customer to compare each type of mattress side-by-side to select a desired type of mattress. Mattresses displayed within the comparison center are further displayed with the designated color.

The method may further include displaying a key for indicating the color designated for each type of mattress. In one example, the key may include a separate display (e.g., a banner) for displaying the type of mattress associated with each color. The key may be displayed anywhere in the showroom, and in one example, is displayed as separate displays adjacent each of the different types of mattresses in a comparison center of the showroom.

In another example, a method for displaying a plurality of mattresses includes designating a different color for each type of mattress, and displaying each of the plurality of mattresses with an associated article having the designated color for the mattress type. The method may further include displaying a subset of the plurality of mattresses in a first region of a showroom, wherein the subset comprises one of each of the at least three different types of mattresses, and grouping the remaining plurality of mattresses in a second region of the showroom based on the type of mattress.

In yet another example, a method for displaying a plurality of mattresses includes displaying each of the plurality of mattresses with an associated color, wherein the color is based on the mattress type. The method may further include displaying a subset of the plurality of mattresses in a first region of a showroom, wherein the subset comprises one of each of at least three different types of mattresses, and grouping the remaining plurality of mattresses in a second region of the showroom based on the type of mattress. The associated color may be included with an article such as a pillow or foot protector displayed with each of the mattresses, or other treatment to the display of the mattress.

In other examples, a visualization scheme (other than text) may be used in addition to or instead of a color scheme in a fashion similar to the described color scheme. For example, a visual pattern (such as strips, dots, cross-hatching, etc.), icons, or the like may be used to provide a visual, non-text based, indicator to a customer of the type of mattress.

According to another aspect of the present invention a system for displaying a plurality of mattresses according to a color scheme is provided. In one example, the system includes a plurality of articles for display with the mattresses, where each article is predominantly one of at least three different colors for display with different mattress types based on a color scheme. The system may further include a key for displaying the type of mattress associated with each color of the plurality of articles to a customer. The key may include a sign or banner indicating the designated color for each type of mattress or a separate display for displaying the type of mattress associated with each color.

Various examples and aspects of the present invention are better understood upon consideration of the detailed description below in conjunction with the accompanying drawings and claims.

### BRIEF DESCRIPTION OF THE DRAWINGS

FIG. 1A schematically illustrates an exemplary layout of a mattress showroom according to one example, where each mattress is displayed with a color (or other visual, non-text based) treatment or indicator associated with the type of mattress;

FIG. 1B schematically illustrates an exemplary layout of a mattress showroom according to another example, where mattresses are displayed with color indicators associated with the type of mattress and are further grouped together by type of mattress;

FIG. 2 schematically illustrates an exemplary layout of a mattress showroom including a comparison center for comparing different types of mattresses;

FIG. 3 schematically illustrates an exemplary layout of a mattress showroom including a comparison center according to another example;

FIG. 4 illustrates an exemplary mattress for display with an article displayed therewith having a designated color for indicating the type of mattress to a customer;

FIG. 5 illustrates an exemplary method for displaying a plurality of mattresses of different types according to one example; and

FIG. 6 illustrates an exemplary method for displaying a plurality of mattresses of different types according to another example.

### DETAILED DESCRIPTION

The following description sets forth numerous specific methods, configurations, parameters, and the like. It should be recognized, however, that such description is not intended as a limitation on the scope of the present invention, but is instead provided as a description of exemplary embodiments. Various modifications to the examples described will be readily apparent to those of ordinary skill in the art, and the general principles defined may be applied to other examples and applications without departing from the spirit and scope of the invention. Thus, the present invention is not intended to be limited to the examples described herein and shown, but is to be accorded a scope consistent with the claims.

Broadly speaking, and in one example, a method and system for displaying mattresses using a color scheme to aid customers in identifying and distinguishing different types of mattresses in a retail store are provided. In particular, and in one example, a method includes using a color scheme for displaying a colored article with each of the plurality of mattresses, where the colored article indicates the type of mattress to the user. The color may be included prominently in an article displayed with the mattress, e.g., a pillow cover, a foot protector, sheet, bed frame or stand, a sign above or behind the bed, combinations thereof, or the like, thereby providing a customer with a clear visual indication of the type of mattress. Exemplary types of mattresses may include contoured, personalized, pillow top, plush, and firm (of course other categorizations of mattress types are contemplated).

Further, in one example, an exemplary method and system for displaying mattresses includes a comparison center for testing and comparing different types of mattresses. For example, a comparison center may generally include a region of the retail store having each different type of mattress displayed and available for side-by-side comparing by a customer. The mattresses within the comparison center are further each displayed with a different color, the color consistent with the particular type of mattress throughout the retail store showroom. Accordingly, a customer may test the mattresses (e.g., look at, lay down, touch, etc.) with the comparison center to determine a desired type of mattress, note the color used with the type of mattress, and seek mattresses with the same color within the showroom. Further, in one example, mattresses of a common type, and displayed with a common color or colored article, are clustered or grouped together in a common region of the showroom.

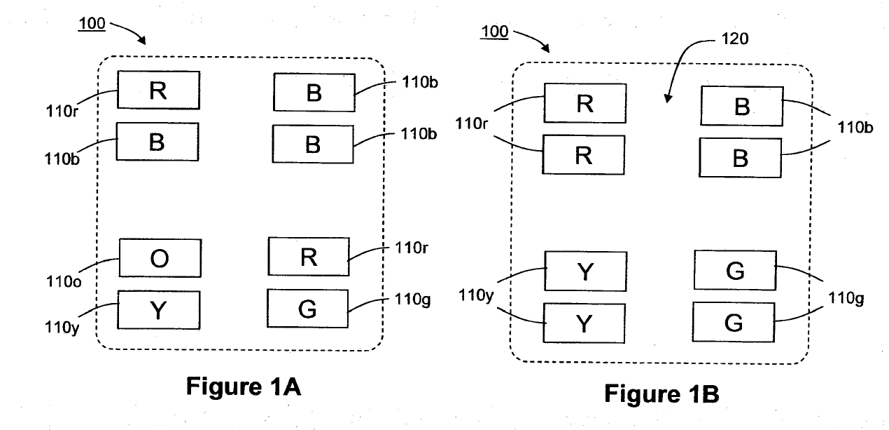

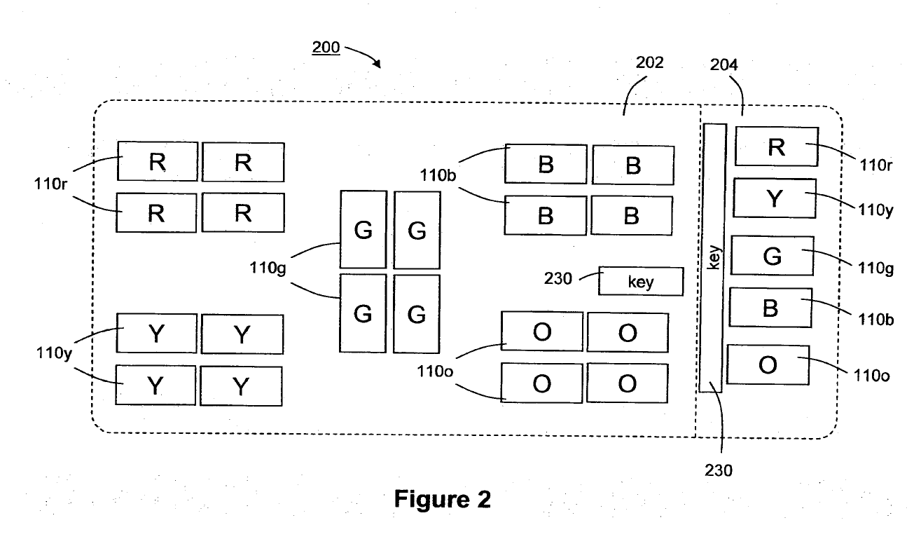

FIG. 1A schematically illustrates an exemplary layout of a retail mattress showroom 100 according to one example, where mattresses are displayed with a visual indicator associated with the type of mattress. In particular, showroom 100 (which may be included with a mattress retail store or part of a department store) includes a plurality of mattresses 110r, 110b, 110o, 110y, and 110g displayed therein, each mattress displayed with an associated color, e.g., red, blue, orange, yellow, and green. For example, a first type of mattress 110r (e.g., a pillow-top mattress) may be associated with the color red, a second type of mattress 110b (e.g., a personalized mattress) may be associated with the color blue, and so on for mattresses 110o, 110y, and 110g. Additionally, the retail store may include a key or legend (see, e.g., FIG. 2) for indicating to the user the type of mattress associated with each displayed color. Accordingly, a user may move through a store or showroom and quickly identify the type of mattress based the color treatment.

The color treatment to each mattress may include displaying an article, such as a pillow, foot protector, sheet, headboard, or the like with the mattress. Additionally, a tag or sales information may further include the color. In other examples, other visual treatments or indicators may be used, in addition to or instead of a color indicator. For example, various visual or optical patterns (other than merely text) for indicating the type of mattress to a customer may be used, such as patterns (e.g., stripes, dots, and so on), icons, or the like that can aid a customer in identifying different types of mattresses.

The mattresses may be categorized or divided into types of mattresses based on comfort categories (e.g., as opposed to manufacturer or conventional sizing terminology such as King size versus Queen size, King size versus a child mattress, and so on). Exemplary comfort types may include contoured, personalized, pillow top, plush, and firm.

FIG. 1B schematically illustrates an exemplary layout of a retail mattress showroom according to another example, where mattresses are displayed with a visual indicator associated with the type of mattress as described with respect to FIG. 1A, and the mattresses are further grouped or clustered together by mattress type. For example, pillow top mattresses 110r, having the color red associated therewith, are clustered or grouped together in a common region of the store 100 (and similarly 110b, 110y, and 110g are clustered together). Accordingly, a customer looking for a particular type of mattress may locate a grouping of mattresses in the showroom in a relatively common location.

It is noted that the grouping of mattresses may be divided, at least in part, by walkways 120 between different types of mattresses. In other examples, however, the clusters may abut directly, and in other examples, there may be some overlap or intermixing of different types of mattresses. Further, it will be recognized that a retail mattress store would further include an entrance, which may be located at any position relative to the showroom layouts. Additionally, an exemplary showroom described herein may part of a stand alone retail mattress store or included within a larger retail store, e.g., within a department store or the like.

FIG. 2 schematically illustrates an exemplary layout of a mattress showroom 200 according to another example. In this example, showroom 200 includes a main showroom portion 202, including a plurality of mattresses displayed with a colored article, e.g., as described with reference to FIGS. 1A and/or 1B. Further, showroom 200 includes a comparison center 204, which includes different types of mattresses displayed side-by-side for comparison by a customer. Accordingly, a customer may first compare the different types of mattresses in comparison center 204, where the different mattresses are advantageously located within a common region of the store. In one example, a customer may find all of the available mattress types within showroom portion 202 in the comparison center 204. A customer may lie down on each mattress, perform body mapping on each mattress, view general sales information/price ranges, and so on to select a desired type of mattress. Further, each mattress in the comparison center 204 is displayed with a color treatment and/or colored article such that the customer may then search the main showroom portion 202 using the color scheme to locate particular mattress types.

Showroom 200 may further include at least one legend or key 230 displayed in the main showroom 200 and/or the comparison center portion 204. For example, key 230 may include one or more signs displaying the color scheme to a user, e.g., displaying that the color red indicates a pillow top mattress, green indicates contoured, and so on. In one example, key 230 comprises a plurality of signs or banners, one included over or adjacent each of the mattresses in the comparison center 204. In other examples, a brochure may be available for the customer to reference while in the showroom.

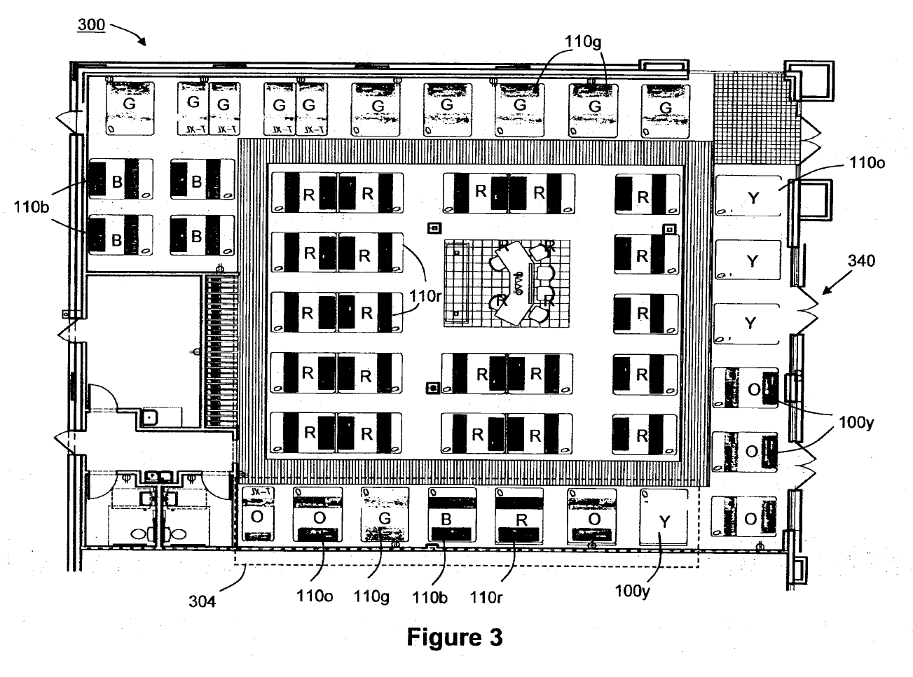

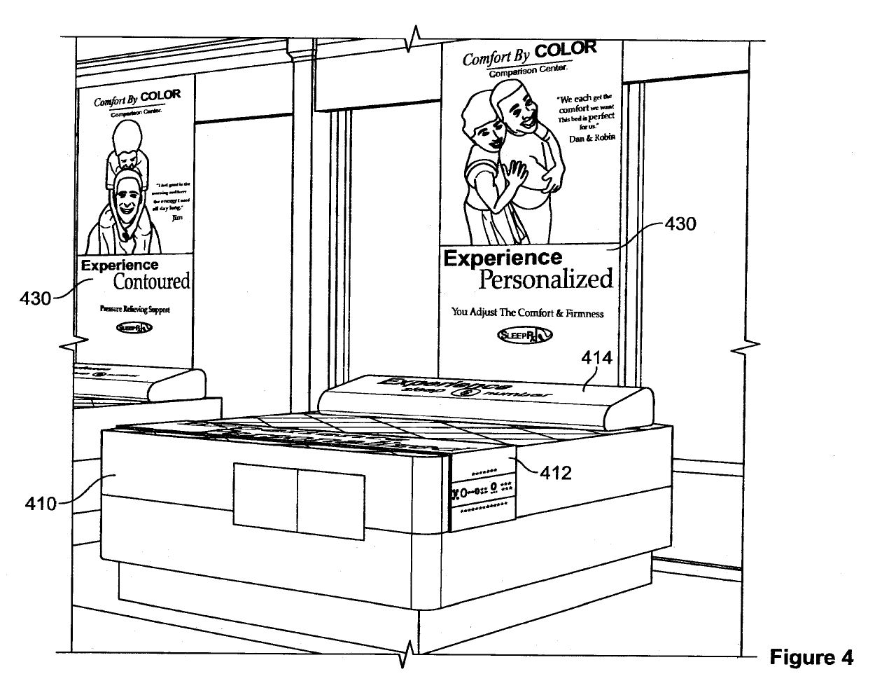

FIG. 3 schematically illustrates an exemplary layout of a retail mattress showroom 300, and treatment of mattresses therein, according to one example. Additionally, FIG. 4 illustrates an exemplary treatment of one of the mattresses shown in FIG. 3 in greater detail.

Retail mattress showroom 300 generally includes a comparison center 304, which includes five different types of mattresses 110r, 110g, 110y, 110b, and 110o (for example, contoured, personalized, pillow top, plush, and firm). The different types of mattresses are displayed with an article of a different color for each type of mattress. For example, with particular reference to FIG. 4, each mattress 110 may include a colored pillow 414 and foot protector 410. In addition to the color, pillow 414 and/or foot protector 412 may further include text indicating the type of mattress (as well as additional text indicating brand names, store names, advertisements, and so on). In other examples, other colored articles such as a top sheet, bed frame, box spring, overhanging sign, floor treatment, or the like may be used. In addition, tags or brochures (whether hanging from the mattress itself or included with a display associated with the mattress) containing information regarding the mattress, prices, warranties, etc., may be colored according to the color scheme.

Additionally, a key 430 may be displayed in the comparison center. In this example, key 430 includes multiple separate displayed, e.g., a different display or banner for display adjacent each type of mattress. Further, in this example, the display of key 430 is colored in a fashion consistent with the treatment or article displayed with mattress 410.

Accordingly, a customer may enter retail store 300 via an entrance 340 and initially compare and select a desired type of mattress in comparison center 304. Once a desired mattress type is selected, the customer can quickly recognize and move through the showroom to find mattresses of the desired type according to the color treatment of the mattresses. Additionally, in this example, the mattresses are displayed grouped or clustered within the showroom (outside of comparison center 304) according to mattress type, which may further aid in identifying the types of mattresses within the showroom (e.g., because all mattresses having a red treatment are grouped together). Additionally, a user may locate all (or a majority) of the mattresses of a given type within a common region. In other examples, however, the mattresses are not grouped by type, and can be grouped by manufacturer, price, randomly, combinations thereof, or the like.

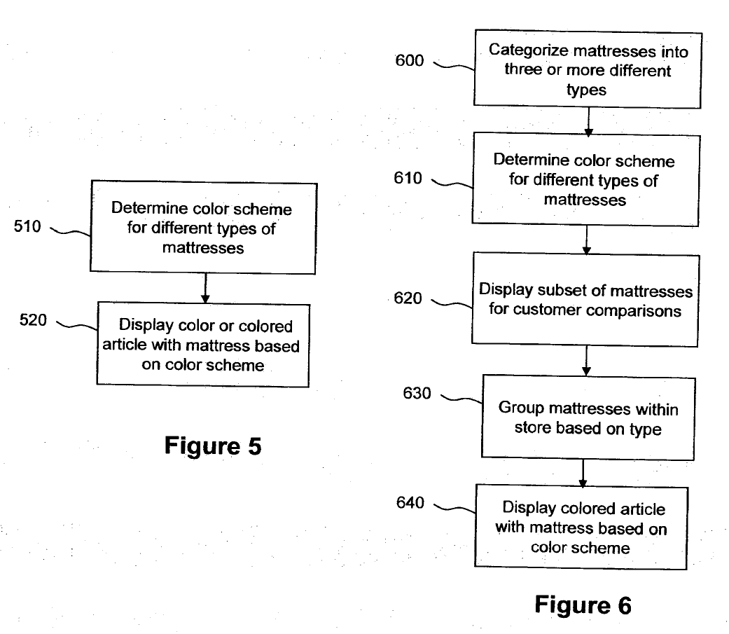

FIG. 5 illustrates an exemplary method for displaying a plurality of mattresses within a retail store showroom, where the plurality of mattresses include multiple types of mattresses. Initially, a color scheme is determined for designating a color to each of the different types of mattresses at 510. For example, different types of mattresses from one or more manufactures may be divided into different category types based on comfort or the like as described herein. Each type of mattress may then be designated or assigned by a particular color for display.

The method further includes displaying the plurality of mattresses at 520, where each mattress is displayed with an associated color or colored article per the designated color determined in 510. In one example, the article may include a colored pillow or foot protector for display with the mattress, thereby providing a visual indicator to customers of the type of mattress.

FIG. 6 illustrates an exemplary method for displaying a plurality of mattresses within a retail store showroom according to another example. Initially, the mattresses are categorized into different types of mattresses at 600. In one example, the mattresses are categorized into three or more types of mattresses, and in one example into five types of mattress. As described, the categorization is based on a feature of the mattresses other than size (i.e., King size, Queen size, etc.), and in one example, is based on a comfort type of the mattress (e.g., contoured, personalized, pillow top, plush, firm, etc.). Similar to the previously described method, a color scheme is determined at 610, where each type of mattress is assigned or designated a different color.

The exemplary method may further include displaying a subset of the mattresses in a first region of the store for comparison by customers at 620. For example, a subset of the mattresses may include one of each type of the plurality of mattresses, where a user may compare the different types of mattresses side-by-side to determine a desired type as described. The exemplary method further includes grouping or clustering the remaining mattresses within the store based on the categorized type at 630.

The method further includes displaying a color or colored article with each of the plurality of mattresses at 640, the color based on the determined color scheme at 610. As described, a colored article may include a pillow and/or foot protector displayed with each mattress. Additionally, a key including a sign or signs may be displayed to indicate which type of mattress has been designated which color, which in one example, is displayed with the mattresses displayed for comparisons (e.g., the comparison center region).

It will be recognized that the exemplary methods described may include additional or fewer acts. For example, the exemplary method of FIG. 6 may omit acts 620 and/or 630. Further, some of the described acts may be carried out in parallel or in other orders, e.g., the mattresses may be displayed grouped by type before a color scheme is determined, a colored article may be displayed with the mattresses before they are grouped by type, and so on.

The foregoing descriptions of specific examples and embodiments have been presented for purposes of illustration and description. They are not intended to be exhaustive, and it should be understood that many modifications and variations are possible in light of the above teaching. Additionally, particular examples have been discussed and how these examples are thought to address certain disadvantages in related art. This discussion is not meant, however, to restrict the various examples to methods and/or systems that actually address or solve the disadvantages.

We claim:

1-26. (canceled)

27. A method for displaying a plurality of mattresses in a showroom, the method comprising:
categorizing the plurality of mattresses into at least two different types of mattresses based on one or more features of the plurality of mattresses other than size;
designating a different color for each type of mattress;
displaying each of the plurality of mattresses with one or more articles, each article having a designated color corresponding to the type of mattress;
displaying a first portion of the plurality of mattresses in a first region of the showroom, wherein the first portion comprises at least one of each type of mattress; and
grouping a second portion of the plurality of mattresses outside of the first region of the showroom, wherein the grouping is based on the type of mattress.

28. The method of claim 27, wherein the one or more articles comprises a foot protector.

29. The method of claim 27, wherein the one or more articles comprises a pillow.

30. The method of claim 27, wherein the one or more articles comprises text related to at least one of the type of mattress, a brand name, a store name, or an advertisement.

31. The method of claim 27, wherein the one or more articles comprises a top sheet, a bed frame, or a box spring.

32. The method of claim 27, further comprising displaying a key for indicating the designated color for each type of mattress.

33. The method of claim 32, wherein the key comprises a sign, a banner or a brochure.

34. The method of claim 27, wherein the plurality of mattresses are categorized based on a comfort type.

35. The method of claim 34, wherein the comfort type is selected from the group comprising contoured, personalized, pillow top, plush, and firm.

36. A method for displaying a plurality of mattresses in a showroom, the method comprising:
categorizing the plurality of mattresses into at least two different types of mattresses based on one or more features of the plurality of mattresses other than size;
designating a different non-text visual indicator for each type of mattress;
displaying each of the plurality of mattresses with one or more articles, each article having a designated non-text visual indicator corresponding to the type of mattress;
displaying a first portion of the plurality of mattresses in a first region of the showroom, wherein the first portion comprises at least one of each type of mattress; and
grouping a second portion of the plurality of mattresses outside of the first region of the showroom, wherein the grouping is based on the type of mattress.

37. The method of claim 36 wherein the non-text visual indicator is a color, a pattern or an icon.

38. The method of claim 36, wherein the one or more articles comprises a foot protector.

39. The method of claim 36, wherein the one or more articles comprises a pillow.

40. The method of claim 36, wherein the one or more articles comprises a top sheet, a bed frame, or a box spring.

41. The method of claim 36, further comprising displaying a key for indicating the designated non-text visual indicator for each type of mattress.

42. The method of claim 36, wherein the plurality of mattresses are categorized based on a comfort type.

43. The method of claim 36, wherein the one or more articles comprises text related to at least one of the type of mattress, a brand name, a store name, or an advertisement.

44. A method for displaying a plurality of mattresses in a showroom, the method comprising:
categorizing the plurality of mattresses into two or more different types of mattresses based on a comfort type;
designating a different color for each type of mattress;
displaying each of the plurality of mattresses with a pillow and a foot protector, wherein each of the pillow and the foot protector comprises at least one of a designated color corresponding to the type of mattress, and text related to at least one of the type of mattress, a brand name, a store name, or an advertisement;
displaying a first portion of the plurality of mattresses in a first region of the showroom, wherein the first portion comprises at least one of each type of mattress;
displaying a second portion of the plurality of mattresses outside of the first region of the showroom, wherein the displaying is based on the type of mattress; and
providing a key for indicating the designated color for each type of mattress.

45. The method of claim 44, further comprising displaying each of the plurality of mattresses with one or more articles, wherein the one or more articles comprises at least one of a top sheet, a bed frame, or a box spring.

46. The method of claim 44, wherein the key comprises a sign, a banner or a brochure.
